(19) United States
(12) Patent Application Publication
(10) Pub. No.: US 2020/0013100 A1
(43) Pub. Date: Jan. 9, 2020

(54) System And Method For Rewarding Buyers

(71) Applicants: Hugues Courchesne, Drummondville (CA); Mathieu Courchesne, Trois-Rivieres (CA); Alain Picard, Saint-Amable (CA)

(72) Inventors: Hugues Courchesne, Drummondville (CA); Mathieu Courchesne, Trois-Rivieres (CA); Alain Picard, Saint-Amable (CA)

(21) Appl. No.: 15/060,043

(22) Filed: Mar. 3, 2016

(51) Int. Cl. G06Q 30/06; G06Q 30/02

(52) U.S. Cl. CPC G06Q 30/0611; G06Q 30/0234; G06Q 30/0641

(57) ABSTRACT

A customized method and system for a buyer to send simultaneous requests for proposals for a specific need to a plurality of sellers who can fulfill that need is disclosed. The system of the invention allows buyers to be matched with sellers by paying a subscription fee and/or the issuance of awards.

### CROSS-REFERENCE TO RELATED APPLICATION

This application claims priority to provisional patent application Ser. No. 62/127,635 entitled “System And Method For Rewarding Buyers”, which is incorporated herein by reference.

### FIELD OF THE INVENTION

The invention relates to internet custom search engines, computer systems and networks, marketing, business solutions and tools for requests for proposals, bids and offers.

### BACKGROUND OF THE INVENTION

Buyers can send many requests for proposals to sellers with various types of communication methods. For example by e-mail, fax, phone, and a social network like Facebook and Linkedin. Buyers currently have a hard time to manage all of the offers coming from sellers because the information is decentralized; they have to process all of the offers' information from many communication systems. This system offers an incentive to the buyer to use a centralized system for sending simultaneous requests for proposals to all potential sellers and compare all of the offers from the sellers under the same system. This demonstrates a need to manage centralized requests for proposals and offers in a system that rewards buyers.

### SUMMARY OF THE INVENTION

According to one embodiment of the invention, provided is a fully customized method and system for a buyer to send simultaneous requests for proposals for a specific need to all sellers who are linked or not linked to the system. According to an embodiment of the invention, provided is a request for proposals system that includes: A system that matches buyers, sellers with the requests for proposal and offers.

According to another embodiment of the invention, a buyer registers to the system and creates a request for proposal. The buyer can send an invitation to sellers who already have an account in the system or by e-mail, but not limited at, to view the request for proposals and reply with offers.

According to another embodiment of the invention, a buyer can be rewarded when they accept a proposal and choose an offer from a seller.

### BRIEF DESCRIPTION OF THE DRAWINGS

FIG. 1 is a schematic drawing of rewarding buyers using a request for proposal system.

### DETAILED DESCRIPTION OF A PREFERRED EMBODIMENT

A buyer logs in to the request for proposal system and creates a detailed request for proposal. The request is stored in the database and is accessible from the sellers who can browse it. A Seller selects a request for proposal and can read it. The sellers (a) have to pay a fee if they want to reply, and make their offers or (b) the sellers can make their offers and pay a fee only if they win the request for proposal bid or (c) the system can force the sellers to pay a fee when replying to make offers and also when winning the request for proposal bid. The buyer then browses the offers from sellers in relation of the request for proposal created. The buyer has to select an offer and accept it. When accepted, the system rewards the buyer.

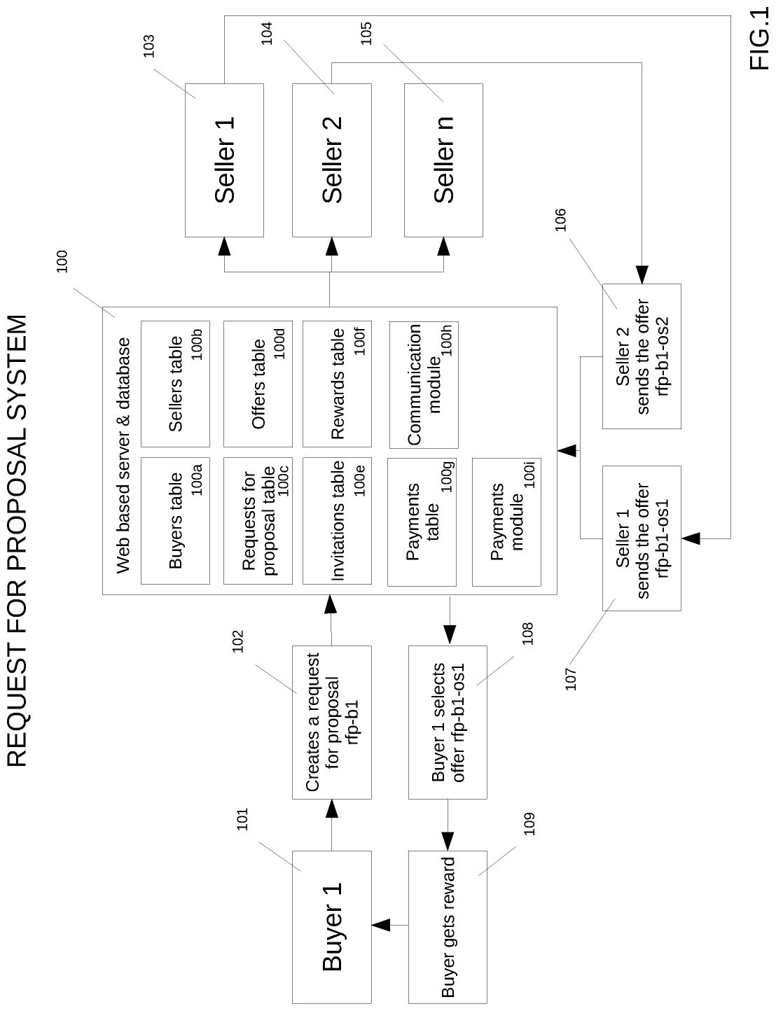

FIG. 1 is a block diagram illustrating a request for proposal that rewards buyers when choosing sellers from this request for proposal offers.

Referring now to the drawing and more particularly to FIG. 1 a block diagram illustrates the request for proposal Web based server and database 100. Buyers table 100a contains all the buyers account data. Sellers 100b contain all the sellers account data.

Buyer 101 sends invitation to Seller 105. Updating the invitation table 100e and then using the communication module 100h to invite seller 105 to connect with Buyer 101 for receiving request for proposal 102.

Request for proposal 102 is saved in the requests for proposal table 100c created by buyer 101. The system 100 can notify sellers 103, 104 and 105 through communication module 100h that new requests for quotations are waiting for their offers.

Sellers 103, 104 and 105 can access request for proposal 102 by browsing the website 100 and link them to their account.

Sellers 103, 104 create their offers 106, 107, updating the offers table 100d. To be able to send their offers 106, 107, a) they pay a fee be able to reply to the buyer 101, orb) the sellers can make their offers and pay a fee only if they win the request for proposal bid or c) the system can force the sellers to pay a fee when replying to make offers and also when winning the request for proposal bid. The payments module 100i, update the payments table 100g.

System 100 sends a notification using the communication module 100h to the buyer 101 to inform him that he received offers 106, 107 from sellers 103, 104. Buyer 101 browses offers 106, 107 from sellers 103, 104 related to the request for proposal 102. Buyer accepts the offer 107, from seller 103 by clicking on “Accept this offer” 108 button, but not limited at. System 100 cumulates the amount of paid fees from sellers 103, 104 for offers 106, 107 and rewards the buyer 101 with payments of a % of the revenue made from these offers 106, 107. Updating rewards table 100f.

While the foregoing specification teaches the principles of the present invention, with examples provided for the purpose of illustration, it will be appreciated by one skilled in the art from reading this disclosure that various changes in form and detail can be made without departing from the true scope of the invention.

What is claimed is:

1. A request for proposal system, said system comprising:
a web based server adapted for a buyer creating a request for proposal to purchase at least one item being offered for sale, said request being stored in a database;
a first electronic communications module adapted for said buyer to send a plurality of invitations and notifications to a plurality of sellers of said item;
a second electronic communications module adapted for said sellers to respond to said buyers with offers of sale in exchange for the payment of a fee; and
using said first electronic communications module, said buyer accepts one of said offers of sale.
